(19) United States
(12) Patent Application Publication
(10) Pub. No.: US 2026/0092183 A1
(43) Pub. Date: Apr. 2, 2026

(54) SURFACE LAYER

(71) Applicant: Shin-Etsu Chemical Co., Ltd., Tokyo (JP)

(72) Inventor: Takashi UCHIDA, Annaka-shi (JP)

(73) Assignee: Shin-Etsu Chemical Co., Ltd., Tokyo (JP)

(21) Appl. No.: 19/328,338

(22) Filed: Sep. 15, 2025

(30) Foreign Application Priority Data
Sep. 30, 2024 (JP) 2024-170697

(51) Int. Cl. C09D 5/16; C08G 77/16; C09D 183/06

(52) U.S. Cl. CPC C09D 5/1675; C08G 77/16; C09D 183/06

(57) ABSTRACT

Provided is a water repellant surface layer having excellent resistance against abrasion that is formed on a base material by a surface treatment agent, said surface treatment agent comprising an alkyl group-containing compound having at least one alkyl group and a base material adhesive group, wherein the surface layer exhibits a peak intensity at 287.5 eV that decreases as an incident angle of X-rays decreases while the surface layer exhibits a peak intensity at 292.5 eV that increases as an incident angle of X-rays decreases, wherein the peak intensities at 287.5 eV and 292.5 eV are measured through XANES measurement, and wherein the ratio of the peak intensity at 292.5 eV when the incident angle is 90° to the peak intensity at 292.5 eV when the incident angle is 15° is 0.90 or less.

### BACKGROUND OF THE INVENTION

### Field of the Invention

The present invention relates to a surface layer applied to a surface of a base material, featuring a thin film with alkyl chains oriented vertically on the base material's surface, which allows the surface layer to have water repellency and abrasion resistance.

### Background Art

Water-repelling treatment is generally performed on the surfaces of articles, such as materials for semiconductor manufacturing processes, mold materials, precision equipment materials, medical equipment parts, automobile parts, building materials, home appliances, office automation equipment, and household goods, to protect these articles.

The water-repelling treatment utilizes an alkyl group-containing silane compound (See JP-A-2002-038092 and JP-A-2021-123678) or a fluoropolyether group-containing silane compound (see, JP-B-6260579, JP-B-6828744, JP-B-5761305, JP-B-6451279, JP-B-6741074, and JP-B-6617853). These silane compounds, applied and cured on the surface of base material of, for example, metal, porcelain, glass, or plastic, form a water-repelling layer on the surface of the base material, thus providing the base material with functionality for preventing dust, finger print, or other contaminants from being adhered thereon.

The above-listed silane compounds have an organic functional group and a reactive silyl group (typically a hydrolysable silyl group such as an alkoxysilyl group) per one molecule. The hydrolysable silyl group undergoes a self-condensation reaction upon exposure to, for example, atmospheric moisture, resulting in the formation of a film. The resulting film is strong and exhibits durability due to the hydrolysable silyl groups, which form physical and chemical bonds to the surface of the base material.

Furthermore, it is disclosed that incorporating a layer of silicon oxide between the base material and the aforementioned silane compound enhances resistance against abrasion and friction. (See, WO-A-2014/097388, JP-A-2020-132498, JP-A-2020-090652, JP-B-5655215, JP-B-6601492, JP-B-5494656, WO-A-2019/035271, WO-A-2023/013476, and WO-A-2023/013477.)

### SUMMARY OF THE INVENTION

It has been found that when an alkyl group-containing compound is applied to the surface of a base material, abrasion resistance may not be obtained depending on the orientation state of the alkyl chains aligned on the outermost surface of the substrate.

The present invention has been made in view of such circumstances, and it is an object of the present invention to provide a water-repelling surface layer that exhibits favorable resistance to abrasion.

The present inventor has diligently studied to solve the above objects and, as a result, has discovered that a surface layer formed on a base material using a surface treatment agent that contains an alkyl group-containing compound is presumed to have alkyl chains in the outermost layer oriented nearly upright relative to the base material layer when the surface layer displays a specific range of spectrum, determined by C—K edge X-ray Absorption Near Edge Structure (XANES) measurement explained hereunder, which therefore provides favorable water-repelling property and abrasion resistance, thus completing the present invention.

Specific measures for solving the objects of the present invention are as outlined below:

<1> A surface layer formed on a base material by a surface treatment agent, said surface treatment agent comprising an alkyl group-containing compound having at least one alkyl group and a base material adhesive group,
wherein the surface layer exhibits a peak intensity at 287.5 eV that decreases as an incident angle of X-rays decreases, while the surface layer exhibits a peak intensity at 292.5 eV that increases as an incident angle of X-rays decreases,
   wherein the peak intensities at 287.5 eV and 292.5 eV are determined by C—K edge X-ray Absorption Near Edge Structure (XANES) measurement, and
   wherein an incident angle of X-rays is determined such that an X-ray in a direction parallel to a test surface has an incident angle of 0° while an X-ray in a direction normal to the test surface has an incident angle of 90°; and
wherein the ratio

$$( {I}_{292.5 eV}^{90 °} / {I}_{292.5 eV}^{15 °} )$$

of the peak intensity

$$( {I}_{292.5 eV}^{90 °} )$$

at 292.5 eV when the incident angle is 90° to the peak intensity

$$( {I}_{292.5 eV}^{15 °} )$$

at 292.5 eV when the incident angle is 15° is 0.90 or less.
<2> The surface layer according to <1>, wherein the alkyl group-containing compound comprises two alkyl groups.
<3> The surface layer according to <1> or <2>, wherein the at least one alkyl group comprises in total 19 or more carbon atoms.
<4> The surface layer according to any one of <1> to <3>, wherein the base material adhesive group in the alkyl group-containing compound is a silanol group, a hydrolysable silyl group, a silazane group, a thiol group, or a phosphonic acid group.
<5> The surface layer according to any one of <1> to <4>, wherein the alkyl group-containing compound is represented by any one of formulae (11), (12), and (13) defined as:

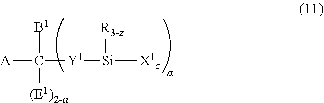

wherein A is an alkyl group having 10 to 50 carbon atoms, B¹ is a hydrogen atom or a hydroxyl group, each E¹ is a hydrogen atom or an alkyl group having 9 to 50 carbon atoms, the total number of carbon atoms contained in A and E¹ is 19 or more, each Y¹ is a single bond, an alkylene group, or a divalent hydrocarbon group containing at least one selected from the group consisting of a silicon atom and a siloxane bond, each R is an alkyl group having 1 to 4 carbon atoms or a phenyl group, each X¹ is independently a hydrolyzable group, z is 2 or 3, and a is 1 or 2;

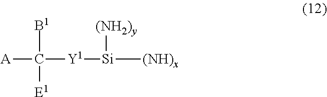

wherein A, B¹, E¹, and Y¹ are as defined above, y is a number of 0 to 3, x is defined as x=(3−y)/2, where the formula (12) denotes a molecular formula of monomer when y=3, while the formula (12) denotes a composition formula of polymer when y<3; and

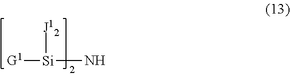

wherein each G¹ independently represents a monovalent hydrocarbon group having 10 to 30 carbon atoms and each J¹ independently represents a hydrogen atom, a hydroxyl group, or a methyl group.
   <6> The surface layer according to any one of <1> to <5>, wherein the surface layer has a film thickness of 2 to 5 nm.
   <7> The surface layer according to any one of <1> to <6>, wherein the surface layer endures 1000 abrasion cycles that maintain resistance to abrasion using a reciprocating abrasion tester performed on the surface layer formed on glass,
wherein the number of abrasion cycles that maintain resistance to abrasion is defined as the number of reciprocations that maintain a water contact angle of 90° or greater with respect to the surface in an abrasion resistance test performed under the conditions of:
Abrasion material: Steel wool of #0000 (Bonstar);
Load: 1 kgf;
Reciprocation distance: 40 mm; and
Reciprocation rate: 60 reciprocation cycles per minute.

The surface layer according to the present invention is characterized by its water-repelling property and durability.

### BRIEF DESCRIPTION OF THE DRAWINGS

FIG. 1 illustrates the spectrum of X-ray absorption near edge structure (XANES) for the surface layer of Working Example 1.

FIG. 2 illustrates the spectrum of X-ray absorption near edge structure (XANES) for the surface layer of Comparative Example 1.

### DETAILED DESCRIPTION OF THE INVENTION

The term “partial (hydrolytic) condensate” as used herein refers to a partial condensate or a partial hydrolytic condensate.

The term “alkyl group” as used herein refers to a linear or branched saturated hydrocarbon group having at least one carbon atom.

The term “hydrocarbon group” as used herein refers to an atomic group remaining after removing one or more hydrogen atoms from a hydrocarbon composed of carbon atoms and hydrogen atoms, and may be linear, branched, or cyclic (including aromatic). The hydrocarbon group as used herein may include substituents, wherein some or all of the hydrogen atoms in the hydrocarbon group are substituted with groups containing atoms other than carbon and hydrogen, or the hydrocarbon group may include groups containing atoms other than carbon and hydrogen which are positioned between carbon atoms.

The present invention will be more specifically described hereunder.

### [Base Material]

Examples of base materials on which the surface layer of the present invention is formed include glass, metal, and plastic.

Examples of the glass include, but are not particularly limited to, soda lime glass, crown glass, lead glass, borosilicate glass, crystallized glass, quartz glass, aluminosilicate glass, Tempax, Pyrex®, and Neoceram. The glass may undergo chemical or physical enforcement. The glass base material may be in the form of a plate, a film, or any other shape.

Examples of the metals include, but are not limited to, pure metals such as aluminum, titanium, chromium, iron, cobalt, zinc, nickel, and copper; alloys such as stainless steel (e.g., SUS304 mirror finish), brass, kovar, and inconel; and those plated with, for example, zinc, nickel, or chromium.

The metal base material may be in the form of a plate, a rod, a sphere, or any other shape.

Examples of the plastics include, but are not limited to, polyethylene, polypropylene, and cellulose-based resins such as triacetyl cellulose; polyester-based resins such as polyethylene terephthalate; polycarbonate; polyimide; polyolefin-based resins; polyvinyl chloride; polyvinyl alcohol; acrylonitrile-butadiene-styrene copolymer (ABS) resin; acrylic resin; nylon; and polyether ether ketone.

The plastic base material may be in the form of a plate, a rod, a sphere, or any other shape.

The base material may be pretreated.

The method of pretreating the base material is not particularly limited as long as it allows contaminants to be removed from the surface of the base material, and makes the surface of the base material hydrophilic. Examples of such method include cleaning treatment with an alcohol such as ethanol or 2-propanol, alkali cleaning treatment with an alkali cleaning agent, and plasma cleaning treatment with an oxygen plasma or argon plasma. They may be used in combination. It is preferable to perform cleaning treatment with an alkali cleaning agent or plasma cleaning treatment with plasma, and it is more preferable to perform alkali cleaning treatment with an alkali cleaning agent, followed by performing plasma cleaning treatment with plasma.

The effects of pretreatment on the base material can be evaluated based on its surface hydrophilicity. The hydrophilicity can be evaluated by the contact angle of water on the base material, and it is preferred that the contact angle be 40° or less, more preferably 20° or less, and even more preferably 10° or less. The water contact angle may be measured in accordance with JIS R 3257:1999.

The present invention may provide a functional layer between the surface layer and the base material. Examples of the functional layer include an antireflection film. A primer layer may also be formed between the surface layer and the base material or between the functional layer and the surface layer.

### [Primer Layer]

The primer layer refers to a thin film having oxidized silicon in an amount of 30% by mass or more, preferably of 50% by mass or more, and even more preferably of 80% by mass or more.

The primer layer may be formed using a wet coating method, particularly by a method such as dip coating, brush coating, spin coating, spray coating, or flow coating, to apply a water dispersion of silica nanoparticles onto the surface of the base material, followed by drying the solvent. The primer layer can be heated at temperatures ranging from 50° C. to 500° C. for durations between 10 minutes and 24 hours to enhance its density, at a temperature within a range that the base material remains unaffected.

The primer coating may also be formed using dry coating methods such as physical vapor deposition and chemical vapor deposition. Examples of the dry coating method include electron beam deposition, ion-assisted deposition, sputtering deposition, and resistance heating deposition.

The primer layer typically has a thickness of 1 to 50 nm, preferably 1 to 20 nm, and particularly preferably 1 to 10 nm, although the thickness is selected as appropriate depending on the type of base material. A film having a thickness below this range may fail to adequately cover the surface, leading to poor adhesion to the surface layer. A film having a thickness above this range may result in poor appearance such as haze and discoloration. As used herein, the film thickness may be measured by, for example, X-ray reflectometry and spectroscopic ellipsometry.

### [Surface Layer]

The surface layer according to the present invention is formed on the outer surface of the base material or on the outer surface of the base material on which the primer layer is further formed. The surface layer is a product formed by a cured product of a surface treatment agent that contains an alkyl group-containing compound exhibiting water-repelling property and having a base material adhesive group. It is preferred that the layer be formed by a cured product of a surface treatment agent that contains an alkyl group-containing compound having no fluorine atom and/or its partial (hydrolytic) condensate.

<Surface Treatment Agent Containing Alkyl Group-Containing Compound with Base Material Adhesive Group and/or its Partial (Hydrolytic) Condensate>

The surface treatment agent forming the surface layer of the present invention includes an alkyl group-containing compound having at least one alkyl group and a base material adhesive group. The alkyl group-containing compound having at least one alkyl group and a base material adhesive group is preferably a compound having two alkyl groups per one molecule, and it is more preferred that the whole alkyl groups have 19 or more carbon atoms.

It is preferred that the at least one alkyl group in the alkyl group-containing compound have in total 19 or more carbon atoms, more preferably 20 or more carbon atoms, even more preferably 22 or more carbon atoms, and particularly preferably 25 or more carbon atoms. The surface layer formed by the surface treatment agent having an alkyl group-containing compound within the above range is expected to exhibit a high degree of orientation of alkyl groups, eccentrically aligned in the outermost surface of the base material (i.e., alkyl groups stand upright to the base material), toward the base material. The resultant surface layer thus formed provides enhanced water repellency and durability. Further, when two or more alkyl groups are present, it is preferred that each alkyl group be linear and have 10 or more carbon atoms, preferably 13 or more carbon atoms, and particularly preferably 15 or more carbon atoms. Furthermore, it is preferred that the two or more alkyl groups be identical to each other.

The alkyl group-containing compound may have any base material adhesive group which is not particularly limited as long as it adheres to various types of base materials. Nevertheless, it is preferred that the base material adhesive group be any one of a silanol group, a hydrolysable silyl group, a silazane group, a thiol group, and a phosphonic acid group.

Examples of hydrolysable groups in the hydrolysable silyl group include: an alkoxy group having 1 to 10 carbon atoms, such as a methoxy group, an ethoxy group, a propoxy group, an isopropoxy group, a butoxy group, an isobutoxy group, a sec-butoxy group, and a tert-butoxy group; an alkoxy-substituted alkoxy group having 2 to 10 carbon atoms, such as a methoxymethoxy group, a methoxyethoxy group, an ethoxymethoxy group, and an ethoxyethoxy group; an acyloxy group having 2 to 10 carbon atoms, such as an acetoxy group and a propionoxy group; an alkenyloxy group having 2 to 10 carbon atoms, such as a vinyloxy group, an allyloxy group, a propenoxy group, and an isopropenoxy group; and halogen groups, such as a chlorine group, a bromine group, and an iodine group. Of these, preferred are a methoxy group, an ethoxy group, an isopropenoxy group, and a chlorine group.

It is preferred that the alkyl group-containing compound be represented by formula (11), (12), or (13), particularly preferably by formula (11), where the compound represented by the formula (12) denotes a molecular formula of monomer or a composition formula of polymer, said formulae (11), (12), and (13) defined as:

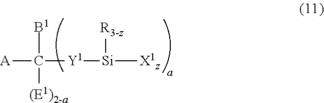

wherein A is an alkyl group having 10 to 50 carbon atoms, B¹ is a hydrogen atom or a hydroxyl group, E¹ is a hydrogen atom or an alkyl group having 9 to 50 carbon atoms, the total number of carbon atoms contained in A and E¹ is 19 or more, Y¹ is a single bond, an alkylene group, or a divalent hydrocarbon group containing at least one selected from the group consisting of a silicon atom and a siloxane bond, R is an alkyl group having 1 to 4 carbon atoms or a phenyl group, X¹ is independently a hydrolyzable group, z is 2 or 3, and a is 1 or 2;

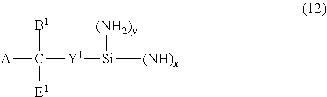

wherein A, B¹, E¹, and Y¹ are as defined above, y is a number of 0 to 3, x is defined as x=(3−y)/2, where the alkyl group-containing compound represented by the formula (12) denotes a molecular formula of monomer when y=3, while the alkyl group-containing compound represented by the formula (12) denotes a composition formula of polymer when y<3; and

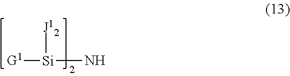

wherein each G¹ independently represents a monovalent hydrocarbon group having 10 to 30 carbon atoms and J¹ independently represents a hydrogen atom, a hydroxyl group, or a methyl group.

In the formulae (11) and (12), A is an alkyl group having 10 to 50 carbon atoms, preferably 17 to 50 carbon atoms, more preferably 17 to 40 carbon atoms, B¹ is a hydrogen atom or a hydroxyl group, and E¹ is a hydrogen atom or an alkyl group having 9 to 50 carbon atoms, preferably 10 to 50 carbon atoms. Examples of alkyl groups for A and E¹ include structures represented by:

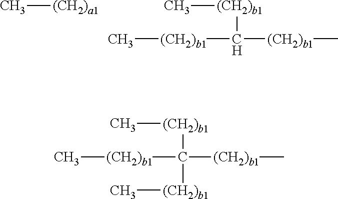

where a1 represents an integer of 8 to 49, preferably of 9 to 49, each b1 independently represents an integer of 1 or more which is determined such that the total number of carbon atoms in each structure is 50 or less, preferably 9 to 43.

A is preferably a linear alkyl group, B1 is preferably a hydroxyl group, and E¹ is preferably a linear alkyl group having 10 to 50 carbon atoms. In the formulae (11) and (12), the total number of carbon atoms contained in A and E¹ is 19 or more, preferably 20 to 60, and more preferably 22 to 60.

In the formulae (11) and (12), Y¹ may be a single bond or a divalent hydrocarbon group, having preferably 1 to 20 carbon atoms, that contains at least one selected from a silicon atom and a siloxane bond. Specific examples of the divalent hydrocarbon group include: an alkylene group having 1 to 20 carbon atoms, preferably 1 to 10 carbon atoms; an alkylene group having 1 to 10 carbon atoms containing an arylene group having 6 to 8 carbon atoms (such as an alkylene-arylene group having 7 to 18 carbon atoms); a divalent group in which an alkylene group having 1 to 8 carbon atoms is bonded to another alkylene group through a diorganosilylene group, a silalkylene structure, or a silarylene structure; and a divalent group in which an alkylene group having 1 to 10 carbon atoms is bonded to a linear organopolysiloxane residue having 2 to 10 silicon atoms, more preferably 2 to 8 silicon atoms, or to a branched or cyclic organopolysiloxane residue having 3 to 10 silicon atoms, more preferably 3 to 8 silicon atoms.

Examples of groups bonded to the silicon atom of, for example, the diorganosilylene group, silalkylene structure, silarylene structure, or organopolysiloxane residue include an alkyl group having 1 to 8 carbon atoms, preferably of 1 to 4 carbon atoms, such as a methyl group, an ethyl group, an propyl group, and a butyl group, and a phenyl group. The alkylene group in the silalkylene structure may be a group having 2 to 6, preferably 2 to 4 carbon atoms, such as an ethylene group, a propylene group (a trimethylene group or a methylethylene group), or a butylene group (a tetramethylene group or a methylpropylene group). Further, the organopolysiloxane residue may contain a silalkylene structure in which two silicon atoms are bonded via an alkylene group such as an ethylene group or a propylene group.

Examples of such Y¹ include those represented by:

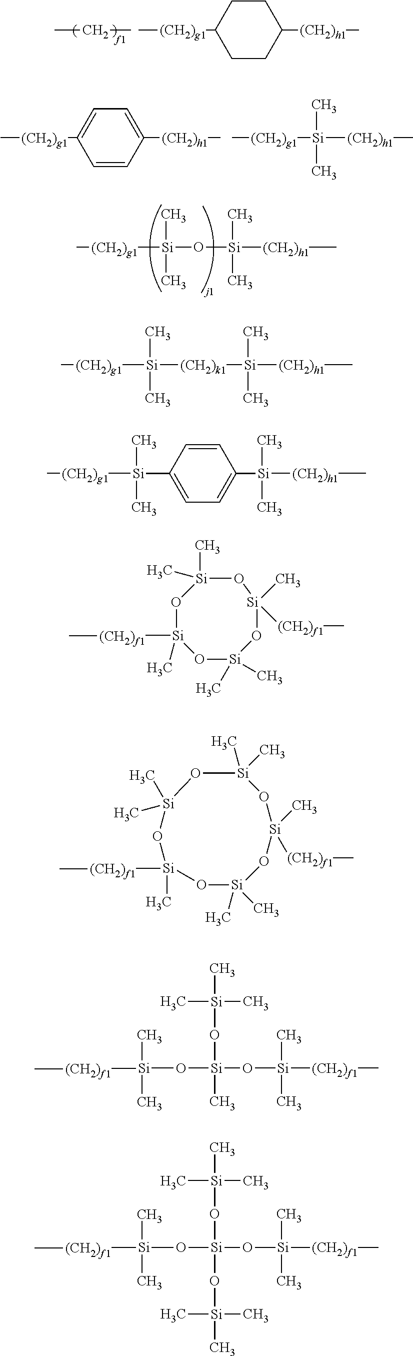

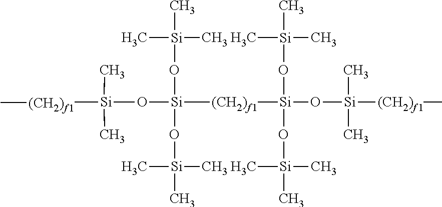

wherein each f1 independently represents an integer of 1 to 10, each of g1 and h1 represents an integer of 1 to 8 provided that the sum of g1 and h1 is an integer of 2 to 10, j1 is an integer of 1 to 9, and k1 is an integer of 2 to 4. In the above structures, it is preferred that the left dangling bond be bonded to a carbon atom and the right bond be bonded to a silicon atom.

In the above formula (11), each X1 independently represents a hydrolysable group. Examples of the hydrolysable group include: an alkoxy group having 1 to 10 carbon atoms, such as a methoxy group, an ethoxy group, a propoxy group, an isopropoxy group, a butoxy group, an isobutoxy group, a sec-butoxy group, and a tert-butoxy group; an alkoxy-substituted alkoxy group having 2 to 10 carbon atoms, such as a methoxymethoxy group, a methoxyethoxy group, an ethoxymethoxy group, and an ethoxyethoxy group; an acyloxy group having 2 to 10 carbon atoms, such as an acetoxy group and a propionoxy group; an alkenyloxy group having 2 to 10 carbon atoms such as a vinyloxy group, an allyloxy group, a propenoxy group, and an isopropenoxy group; and halogen groups, such as a chlorine group, a bromine group, and an iodine group. Of these, preferred are a methoxy group, an ethoxy group, an isopropenoxy group, and a chlorine group.

In the above formula (11), R is an alkyl group having 1 to 4 carbon atoms or a phenyl group, and among these, a methyl group and an ethyl group are preferred. In the above formula (11), z is 2 or 3 and is preferably 3.

In the above formula (12), y is a number of 0 to 3 (0 or a positive number of 3 or less), preferably of 0 to 2, and more preferably of 0. Further, x is (3−y)/2, preferably 1.5. The formula (12) represents a molecular formula of monomer when y=3, while the formula (12) represents a composition formula of polymer when y<3.

In the above formula (13), each G¹ independently represents a monovalent hydrocarbon group having 10 to 30 carbon atoms, preferably 10 to 28 carbon atoms, and examples of which include those represented by:

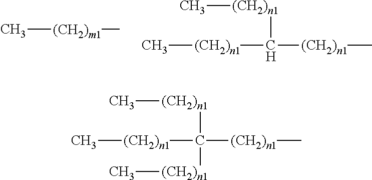

wherein, m1 is an integer of 9 to 29, preferably of 9 to 27, each n1 independently represents an integer of 1 or more which is determined such that the total number of carbon atoms in each structure is 10 to 30, preferably 10 to 28.

In the above formula (13), J¹ independently represents a hydrogen atom, a hydroxyl group, or a methyl group of which preferred is a methyl group.

Specific examples of the compound represented by the above formula (11) include eicosyltrichlorosilane, docosenyltriethoxysilane, triacontyltrichlorosilane, and a compound represented by

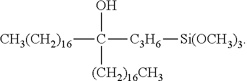

Specific examples of the compound represented by the above formula (12) include compounds represented by

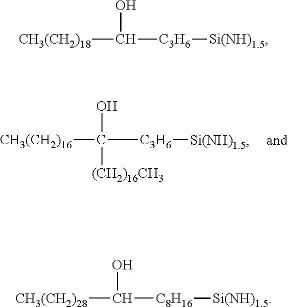

Specific examples of the compound represented by the above formula (13) include 1,3-dioctadecyl-1,1,3,3-tetramethyldisilazane, 1,3-didodecyl-1,1,3,3-tetramethyldisilazane, and 1,3-didecyl-1,1,3,3-tetramethyldisilazane.

Examples of the method for producing the compound represented by the above formula (11) in which E¹ is an alkyl group having 9 to 50 carbon atoms include methods as explained below.

One method (Preparation method 1) is a method for producing the compound involving mixing of a hydrocarbon terminal end group-containing compound, which has an alkenyl group at the terminal of the molecular chain, with a compound containing an SiH group and a hydrolysable silyl group, followed by undergoing a hydrosilylation addition reaction in the presence of a hydrosilylation reaction catalyst to produce the intended product.

Another method (Preparation method 2) is a method for producing the compound involving mixing of a hydrocarbon terminal end group-containing compound, which has an SiH group at the terminal of the molecular chain, with a compound containing an alkenyl group and a hydrolysable silyl group, followed by undergoing a hydrosilylation addition reaction in the presence of a hydrosilylation reaction catalyst to produce the intended product.

Here, examples of the hydrocarbon terminal end group-containing compound, which has an alkenyl group at the terminal of the molecular chain, include a compound represented by formula (11a) defined in the following as

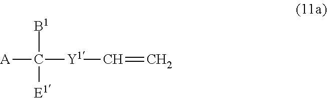

wherein, A and B′ are as defined above and E^{1′} is an alkyl group having 9 to 50 carbon atoms provided that the total number of carbon atoms contained in A and E^{1′} is 19 or more, and Y^{1′} is a divalent hydrocarbon group, preferably having 1 to 18 carbon atoms, that may contain at least one selected from a silicon atom and a siloxane bond.

In the above formula (11a), E^{1′} is an alkyl group having 9 to 50 carbon atoms, and examples of which include those already explained for the alkyl group of E having 9 to 50 carbon atoms. In the above formula (11a), Y^{1′} is a divalent hydrocarbon group, preferably having 1 to 18 carbon atoms, that may contain at least one selected from a silicon atom and a siloxane bond, and examples of which include structures represented by:

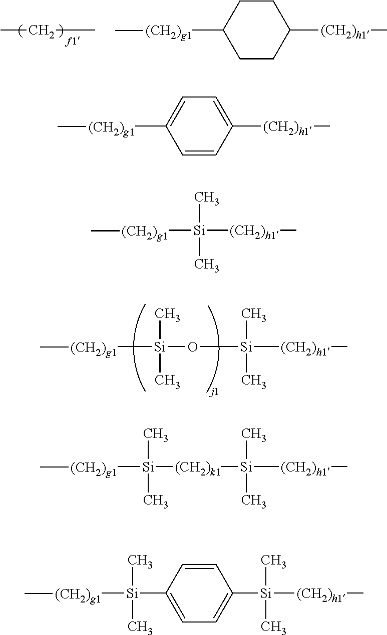

wherein g1s, j1, and k1 are as defined above, f1′ represents an integer of 0 to 8, each h1′ represents an integer of 0 to 6, and the sum of g1 and h1′ is an integer of 2 to 8.

It is preferred in each of the above structures that the left dangling bond be bonded to a carbon atom to which A, B, or E^{1′} is bonded while the right bond be bonded to a vinyl group.

Examples of the compound represented by the formula (11a) include a compound represented by

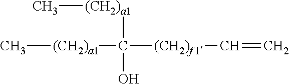

wherein a1s and f1′ are independently as defined above.

Examples of the compound containing an SiH group and a hydrolysable silyl group include trimethoxysilane, triethoxysilane, triacetoxysilane, and trichlorosilane.

The amount of the compound containing an SiH group and a hydrolysable silyl group used in the preparation method 1 is preferably 1 to 6 moles, more particularly 1.5 to 4 moles, per 1 mole of the alkenyl groups in the hydrocarbon terminal end group-containing compound, which has an alkenyl group at the terminal of its molecular chain.

Examples of the hydrocarbon terminal end group-containing compound which has an alkenyl group at the terminal of its molecular chain include a compound represented by formula (11b) defined as

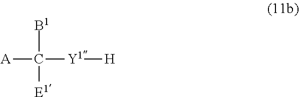

wherein A, B¹, and E^{1′} are as defined above, and Y^{1″} is a divalent hydrocarbon group containing a silicon atom or a siloxane bond.

In the above formula (11b), Y^{1″} is a divalent hydrocarbon group containing a silicon atom or a siloxane bond, and examples of which include those represented by

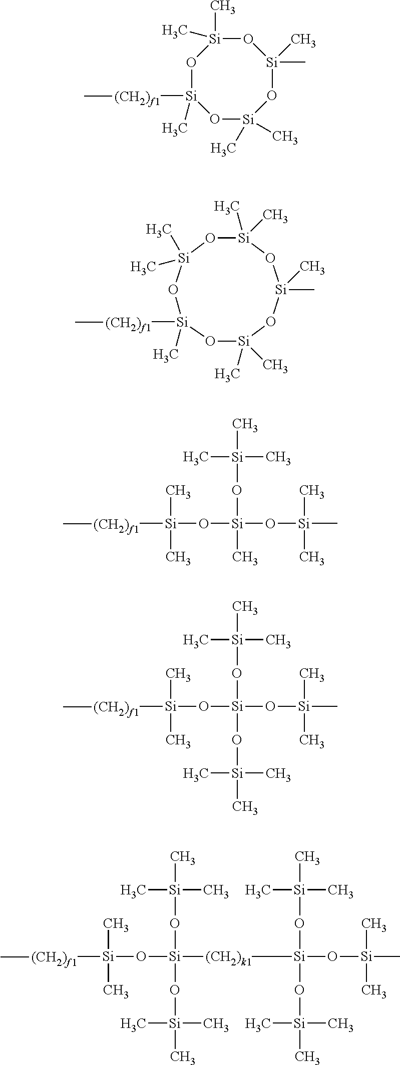

wherein f1s and k1 are as defined above.

It is preferred in each of the above structures that the left dangling bond be bonded to a carbon atom while the right bond be bonded to a hydrogen atom.

Examples of the compound represented by the formula (11b) include a compound represented by

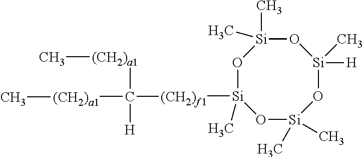

wherein a1s and f1 are independently as defined above.

Examples of the compound containing an alkenyl group and a hydrolysable silyl group include vinyltrimethoxysilane, allyltrimethoxysilane, and octenyltrimethoxysilane.

The amount of the compound containing an alkenyl group and a hydrolysable silyl group used in the preparation method 2 is preferably 1 to 5 moles, more particularly 1 to 3 moles, per 1 mole of the SiH groups in the hydrocarbon terminal end group-containing compound, which has an SiH group at the terminal of its molecular chain.

Examples of the hydrosilation catalyst used in the preparation method 1 or 2 include platinum group metal-based catalysts such as platinum black, chloroplatinic acid, alcohol-modified chloroplatinic acid, complexes of chloroplatinic acid with olefin, aldehyde, vinyl siloxane, and acetylene alcohol, tetrakis(triphenylphosphine)palladium, and chlorotris(triphenylphosphine)rhodium. Preferred are platinum compounds such as vinyl siloxane coordination compounds. It is preferred that the platinum-based compounds be used in a state solubilized in a solvent such as toluene, a lower alcohol, a higher alcohol, and a silicone-based solvent.

The hydrosilation catalyst is preferably used in an amount to provide 0.001 to 1000 ppm, more preferably 0.01 to 100 ppm in terms of transition metal (mass) based on the mass of the hydrocarbon terminal end group-containing compound which has an alkenyl group or an SiH group at the terminal of its molecular chain.

A solvent may be used to perform the reaction in the preparation method 1 or 2. Examples of such solvent include aromatic hydrocarbons such as toluene and xylene, aliphatic or alicyclic hydrocarbons such as n-pentane, n-hexane, and cyclohexane, cyclic ether compounds such as tetrahydrofuran and dioxane, and ketones such as acetone and methyl ethyl ketone.

The solvent is preferably used in an amount of 0 to 1,000 parts by mass, preferably 50 to 200 parts by mass, based on 100 parts by mass of the hydrocarbon terminal end group-containing compound which has an alkenyl group or an SiH group at the terminal of its molecular chain.

In the preparation methods 1 and 2, it is preferable for the reaction of the hydrocarbon terminal end group-containing compound, which has an alkenyl group at the terminal of the molecular chain, with the compound containing an SiH group and a hydrolysable silyl group and the reaction between the hydrocarbon terminal end group-containing compound, which has an SiH group at the terminal of its molecular chain with the compound containing an alkenyl group and a hydrolysable silyl group to be respectively performed under the conditions at a temperature of 20 to 120° C., particularly 60 to 100° C., for 0.5 to 72 hours, particularly for 1 to 36 hours.

The compound represented by the formula (12), where E¹ is an alkyl group having 9 to 50 carbon atoms may be produced following the method explained below.

The hydrocarbon terminal end group-containing compound, which has an alkenyl group at the terminal of the molecular chain, is mixed with trichlorosilane to make them react with each other in the presence of a hydrosilylation reaction catalyst, followed by making the resultant compound react with ammonia gas to produce the intended compound.

Here, the reaction product of trichlorosilane with the hydrocarbon terminal end group-containing compound, which has an alkenyl group at the terminal of the molecular chain, may be prepared following the same method as the preparation method 1 described above.

The amount of ammonia gas used in the method for preparing the compound represented by the formula (12) is preferably 1 to 300 cc/minute, particularly 30 to 200 cc/minute.

In the method for preparing the compound represented by the formula (12), it is preferable for the reaction between ammonia gas and the reaction product of trichlorosilane with the hydrocarbon terminal end group-containing compound, which has an alkenyl group at the terminal of the molecular chain to be performed in the conditions at room temperature (23±15° C. same hereunder), particularly at 20 to 30° C., for 2 to 36 hours, particularly 4 to 12 hours.

The surface treatment agent, containing an alkyl group-containing compound, having a base material adhesive group, and/or its partial (hydrolytic) condensate, may include, as necessary, a hydrolysis condensation catalyst selected from, for example, organotin compounds (such as dibutyltin dimethoxide and dibutyltin dilaurate), organotitanium compounds (such as tetra-n-butyl titanate), organic acids (such as acetic acid, methanesulfonic acid, and fluorine-modified carboxylic acid), and inorganic acids (such as hydrochloric acid and sulfuric acid). Of these, preferred are acetic acid, tetra-n-butyl titanate, and dibutyltin dilaurate. The catalyst is added in a catalytic amount which is normally 0.01 to 5 parts by mass, particularly 0.1 to 1 parts by mass, based on 100 parts by mass of the alkyl group-containing compound and/or its partial (hydrolytic) condensate.

A solvent may be contained in the surface treatment agent that contains the alkyl group-containing compound, having a base material adhesive group, and/or its partial (hydrolytic) condensate. Preferable examples of such solvent include a hydrocarbon-based solvent (such as petroleum benzine, mineral spirits, toluene, and xylene), a ketone-based solvent (such as acetone, methyl ethyl ketone, and methyl isobutyl ketone), an alcohol-based solvent (such as ethanol, 1-propanol, 2-propanol, and butanol), and an ether-based solvent (such as tetrahydrofuran (THF), monoethylene glycol dimethyl ether, diethylene glycol dimethyl ether, triethylene glycol dimethyl ether, tetraethylene glycol dimethyl ether, and dioxane).

Two or more types of the above-listed solvents may be mixed and it is preferred that these solvents uniformly dissolve the alkyl group-containing compound, having a base material adhesive group, and/or its partial (hydrolytic) condensate. The alkyl group-containing compound, having a base material adhesive group, and/or its partial (hydrolytic) condensate to be dissolved in a solvent has an optimal concentration which is not particularly limited and may be suitably determined according to the manner the surface treatment agent is used. The alkyl group-containing compound having a base material adhesive group is dissolved in the surface treatment agent to have a concentration of preferably 0.01 to 30% by mass, more preferably of 0.02 to 25% by mass, and even more preferably of 0.05 to 20% by mass.

It is preferred that the surface layer be formed by a process in which the surface treatment agent, containing the alkyl group-containing compound having a base material adhesive group and exhibiting water-repelling property, is applied using a wet or dry coating method to the outer surface of the primer layer having been formed by the method as explained above, and then the solvent is evaporated and removed from the surface treatment agent while curing the alkyl group-containing compound, having a base material adhesive group, and/or its partial (hydrolytic) condensate.

The surface layer formed by the surface treatment agent can be created using a wet coating method, such as brush coating, dip coating, or spray coating, or through a dry coating method such as vapor deposition, including physical vapor deposition (PVD) and chemical vapor deposition (CVD).

After the surface treatment agent is applied, the solvent is evaporated and removed while the curing process is performed. The wet coating method may be performed at 60 to 150° C., preferably at 60 to 120° C., under a relative humidity of 95% or lower for 30 minutes to 24 hours, preferably for 30 minutes to 2 hours. The dry coating method may be performed at 25 to 150° C., preferably at 25° C. to 80° C., under a relative humidity of 95% or lower for 30 minutes to 48 hours, preferably for 30 minutes to 24 hours.

The surface layer has a film thickness of 2 to 5 nm. A surface layer having a film thickness below 2 nm may result in insufficient mechanical strength, compromising durability, while a surface layer having a thickness exceeding 5 nm may reduce adhesivity to the base or primer layer, thereby impairing water-repelling properties and durability. As used herein, the film thickness may be measured by, for example, X-ray reflectometry or spectroscopic ellipsometry.

The measurement of C—K edge x-ray absorption near edge structure (XANES) of the measurement samples of the surface layer of the present invention formed on the base material demonstrates that the surface layer according to the present invention exhibits an intensity of the peak at 287.5 eV corresponding to 1 s→Rydberg/σ*(C—H) that decreases as an incident angle of X-ray decreases while the layer also exhibits an intensity of the peak at 292.5 eV corresponding to the 1 s→σ*(C—C) that increases as the incident angle of X-ray decreases when the incident angle of X-ray is determined such that an X-ray in a direction parallel to a test surface has an incident angle of 0° while an X-ray in a direction normal to the test surface has an incident angle of 90°. This behavior indicates that the alkyl group chains in the alky compound, forming the surface layer, are oriented to be aligned.

It is also preferred that the ratio

$$( {I}_{292.5 eV}^{90 °} / {I}_{292.5 eV}^{15 °} )$$

of a 292.5 eV peak intensity

$$( {I}_{292.5 eV}^{90 °} )$$

at an incident angle of 90° to a 292.5 eV peak intensity

$$( {I}_{292.5 eV}^{15 °} )$$

at an incident angle of 15° be 0.90 or less. That is, it is preferred that the alkyl group chains be aligned to stand upright to the surface of the base material.

The water repellant product of the present invention may be applied to various types of products including, for example, mobile electronic devices, household electrical appliances, automobiles, outdoor products, building materials, housing equipment, housings for eyeglasses and the like, frames, floors, touch panels, windows, lenses, display covers, and protective films.

### WORKING EXAMPLES

The present invention will be described more specifically below with reference to the working and comparative examples, but the present invention is not limited to the following examples. In the following examples, the molar amounts of the compounds refer to values calculated by dividing the measured mass of each target compound by the molecular weight of the polymer, as determined through 1H-NMR analysis. The tests were performed under the conditions at 23° C. and a relative humidity of 50%.

### Working Example 1

### [Alkaline Cleaning of Base Material]

A base material of soda-lime glass was dipped in an alkaline cleaning liquid (an aqueous solution of Semi-Clean L.G.L by Yokohama Oils & Fats Industry Co., Ltd. diluted to 5% by mass) and ultrasonically cleaned for 5 minutes. Then, the base material was dipped in ion exchanged water and ultrasonically cleaned for 6 minutes. The base material was dried by ejecting compressed air to blow off water.

### [Forming of Primary Layer]

A film forming spattering device was used under the following conditions to form a film of SiO₂ having a thickness of 10 nm on the surface of the glass base material subjected to the alkaline cleaning mentioned above. Oxygen plasma irradiation was performed before forming the SiO₂ film. The rate at which the SiO₂ film was formed was 0.3 nm/second, and the thickness of the film was controlled by the duration for which the film was formed.

### [SiO₂ Film-Forming Condition]

Film-forming device: RAS-1100B (manufactured by SHINCRON CO., LTD)

Oxygen plasma irradiation conditions during base material pretreatment

| Oxygen gas flow rate: | 70 sccm (Standard | |
|---|---|---|
| | Cubic Centi Meters) | |
| Argon gas flow rate: | 100 | sccm |
| Film forming chamber | 0.1 | Pa |
| pressure: | | |
| RF power: | 3000 | W |
| Processing time: | 50 | seconds |

SiO₂ film-forming condition

| Target material: | Silicone | |
|---|---|---|
| Argon gas flow rate: | 100 | sccm |
| Film forming chamber | 0.1 | Pa |
| pressure: | | |
| RF power: | 8000 | W |
| Film-forming rate: | 0.3 | nm/s |

Oxygen plasma irradiation conditions during SiO₂ film formation

| | | |
|---|---|---|
| Oxygen gas flow rate: | 70 | sccm |
| RF power: | 3000 | W |

### [Preparation of Surface Layer Forming Agent 1]

Into a reaction container was mixed 1.00 g (1.82× 10-3 mol) of compound represented by formula (a) defined as

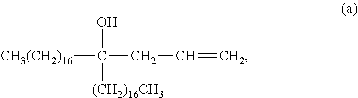

1.00 g of toluene, 0.667 g (5.46×10⁻³ mol) of trimethoxysilane, and 6.62×10⁻³ g of a toluene solution of chloroplatinic acid/vinylsiloxane complex (containing 2.05×10⁻⁸ mol of Pt alone), and the mixture was aged at 80° C. for 24 hours. The solvent and unreacted products contained therein were then removed under reduced pressure to produce a product.

It was demonstrated from the result of ¹H-NMR measurement that the resultant compound had a structure represented by formula (A) defined as:

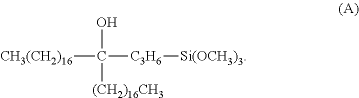

The compound represented by the formula (A) was dissolved in propylene glycol monomethyl ether (PGME) to have a concentration of 10% by mass, and the resultant solution was used as the one denoted by “Surface layer forming agent 1”.

### [Method for Forming Surface Layer]

A base material of the soda-lime glass provided with the SiO₂ film and a mirror-polished Si wafer base material were placed into a resistance heating-type vacuum deposition device (VTR-350M by ULVAC KTKO, Inc.), followed by delivering 10 μL of the surface layer forming agent, shown in the following, to the resistance heating part by drops and reducing the pressure. Resistance heating was started once the pressure inside the container was reduced to 6×10⁻³ Pa or lower. The electric power consumed for resistance heating was adjusted so that a maximum evaporation rate at a quartz crystal film thickness meter installed in a location about 20 cm away from the resistance heating part would be 1.0 nm/second, after which the resistance heating was continued for 300 seconds. In order to cool the device, the device was left to stand for 5 minutes, followed by opening the device to the atmosphere so as to obtain a glass base material to which the surface layer is applied. The above-mentioned base material was left in an environment of 80° C., relative humidity of 80% for 4 hours to fix the surface layer, thus obtaining a glass base material having a surface layer formed by the cured product of the compound (A).

### [XANES Measurement and Analysis]

X-ray was irradiated on the glass base material having the above-mentioned surface layer to measure its absorption amount to determine the X-ray absorption near edge structure (XANES) spectrum. The measurement conditions and the analysis conditions were as follows.

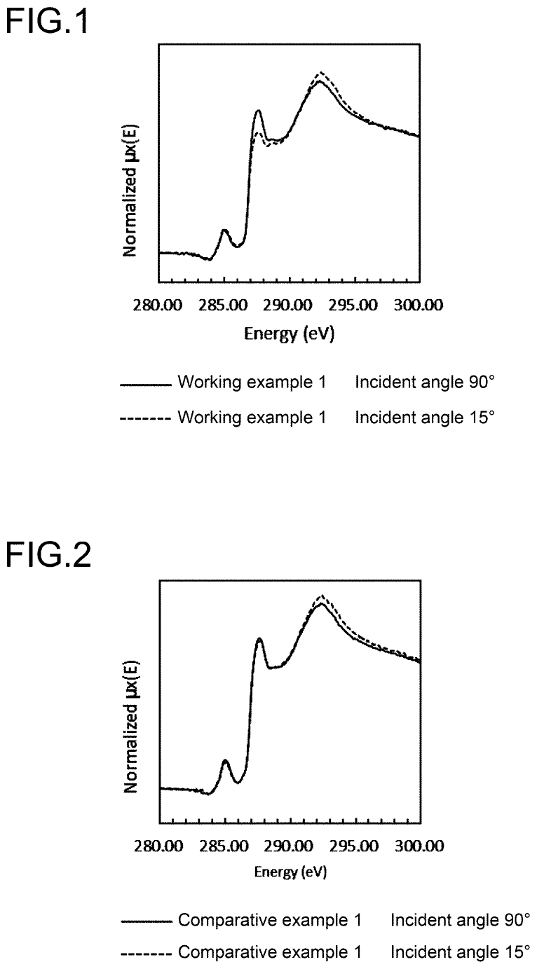

FIG. 1 illustrates the XANES spectrum of the C—K absorption edge, while Table 1 shows the analysis results.

| | |
|---|---|
| Detection method: | Total electron yield method |
| Absorption edge: | K absorption edge of carbon (C) |
| Abscissa correction: | Correction of the Π* peak of highly aligned |
| | pyrolytic graphite to 255.5 eV |

For the XANES spectrum at the carbon K absorption edge, the angle formed between the incident X-ray and the longitudinal vector of the surface of the Si wafer base material, provided with the surface layer, was defined as 0. The peak intensities at 287.5 eV, corresponding to 1 s→Rydberg/σ*(C—H), were calculated for θ=90° and θ=15°, respectively. These peak intensities are denoted as:

$${I}_{287.5 eV}^{90 °}$$

for the peak intensity at 287.5 eV when θ=90° (incident angle of 90°), and

$${I}_{287.5 eV}^{15 °}$$

for the peak intensity at 207.5 eV when θ=15° (incident angle of 15°).

Similarly, the peak intensities at 292.5 eV, corresponding to 1 s→σ*(C—C), were also calculated for θ=90° and θ=15°, respectively, from which the ratio between them was calculated. These peak intensities and the ratio therebetween are represented by:

$${I}_{292.5 eV}^{90 °}$$

for the peak intensity at 292.5 eV when θ=90° (incident angle of 90°);

$${I}_{292.5 eV}^{15 °}$$

for the peak intensity at 292.5 eV when θ=15° (incident angle of 15°); and

$${I}_{292.5 eV}^{90 °} / {I}_{292.5 eV}^{15 °}$$

### [Film Thickness Measurement of Surface Layer]

The film thickness of the surface layer was measured using X-ray reflectivity techniques. Specifically, the measured profile was subjected to simulation fitting to obtain the thickness. The results are as shown in Table 1.

The measurement was carried out under the following conditions:

| Analyzer: | SmartLab (Rigaku Corp.) |
|---|---|
| X-ray source: | Rotating anode (Cu), output 45 kV, 200 mA |
| Incident optical system: | Ge (111) asymmetric beam compression crystal |
| Detector solar slit: | 5.0° |
| Slit: | Incident side IS = 0.05 mm |
| | Detector side RS1 = 0.1 mm, RS2 = 0.1 mm |
| Scanning conditions: | Scanning axis 2θ/ω |
| | Scanning speed 0.2°/min |
| Step width: | 0.002° |

### [Measurement of Water Contact Angle on Surface Layer]

The water contact angle of the surface layer was measured using a contact angle meter of Drop Master (DMo-701SA manufactured by Kyowa Interface Science, Inc) (Liquid droplet: 2 μl, temperature: 25° C.; relative humidity: 40%). To measure the water contact angle, droplets, 1 second after being dropped, were photographed using a CCD camera connected to the previously mentioned contact angle measuring device, and the obtained liquid droplet image was analyzed by contact angle analysis software FAMAS attached to the contact angle meter to determine the contact angle between the glass base plate and the liquid droplet. The contact angle was calculated by the θ/2 method. The analysis conditions are as shown below. The results are as shown in Table 1.

[Analysis condition]

| | |
|---|---|
| Technique: | Liquid droplet method (θ/2 method) |
| Droplet recognition: | Automatic |
| Droplet recognition line | 50 dots |
| (Distance from needle tip): | |
| Algorithm: | Automatic |
| Image mode: | Frame |
| Threshold level: | Automatic. |

### [Abrasion Resistance Test]

A reciprocating abrasion tester (Type 40, manufactured by Shinto Scientific Co., Ltd.) was used to examine the abrasion resistance of the surface layer of the base material of the soda-lime glass provided with the SiO₂ film under the conditions of:

| | |
|---|---|
| Abrasion material: | Steel wool of Bonstar #0000 manufactured |
| | by NIHON STEEL WOOL Co., Ltd.; |
| Load: | 1 kgf; |
| Reciprocation distance: | 40 mm; and |
| Reciprocation rate: | 60 reciprocation cycles per minute. |

The water contact angle of the abrasion worn part was measured every 500 reciprocating abrasion cycles using the same method as above. The number of reciprocating cycles at which the water contact angle was maintained at 90° or more was determined as the number of abrasion cycles that maintained resistance to abrasion. The results are as shown in Table 1.

### Comparative Example 1

Into a reaction container was mixed 1.00 g (3.08× 10⁻³ mol) of compound represented by formula (b) defined as

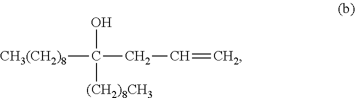

1.00 g of toluene, 1.129 g (9.24×10⁻³ mol) of trimethoxysilane, and 1.01×10⁻² g of a toluene solution of chloroplatinic acid/vinylsiloxane complex (containing 3.08×10⁻⁸ mol of Pt alone), and the mixture was aged at 80° C. for 24 hours. The solvent and unreacted products contained therein were then removed under reduced pressure to produce a product.

It was demonstrated from the result of ¹H-NMR measurement that the resultant compound had a structure represented by formula (B) defined as

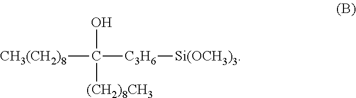

The compound represented by the formula (B) was dissolved in propylene glycol monomethyl ether (PGME) to have a concentration of 10% by mass and the resultant solution was used as the one denoted by “Surface layer forming agent 2”.

A glass base material formed with the surface layer, prepared using the same method as described in Working Example 1, underwent XANES measurement, film thickness measurement, water contact angle analysis, and an abrasion resistance test. FIG. 2 illustrates the XANES spectrum at the C—K absorption edge, while the remaining results are as shown in Table 1.

TABLE 1

| | Working | Comparative |
|---|---|---|
| | example 1 | example 1 |
| ${I}_{287.5 eV}^{90 °}$ | 2.23 | 1.93 |
| ${I}_{287.5 eV}^{15 °}$ | 1.81 | 1.91 |
| ${I}_{292.5 eV}^{90 °}$ | 3.29 | 3.02 |
| ${I}_{292.5 eV}^{15 °}$ | 3.69 | 3.25 |
| ${I}_{292.5 eV}^{90 °} / {I}_{292.5 eV}^{15 °}$ | 0.89 | 0.93 |
| Film thickness (nm) | 2.3 | 1.2 |
| Water contact angle (°) | 104 | 103 |
| Number of cycles that maintain | 3000 | 500 |
| resistance to abrasion | | |
| (# of reciprocations) | | |

These results of the C—K edge x-ray absorption near edge structure (XANES) measurement demonstrated that the surface layer, shown in the working example, exhibited a 287.5 eV peak intensity that decreased as the incident angle of X-rays decreased, while the 292.5 eV peak intensity increased as the incident angle of X-rays decreased. Furthermore, the ratio between these peak intensities was found to be 0.90 or less, indicating that the surface layer provides a high level of abrasion resistance.

What is claimed is:

1. A surface layer formed on a base material by a surface treatment agent, said surface treatment agent comprising an alkyl group-containing compound having at least one alkyl group and a base material adhesive group,
wherein the surface layer exhibits a peak intensity at 287.5 eV that decreases as an incident angle of X-rays decreases, while the surface layer exhibits a peak intensity at 292.5 eV that increases as an incident angle of X-rays decreases,
wherein the peak intensities at 287.5 eV and 292.5 eV are determined by C—K edge X-ray Absorption Near Edge Structure (XANES) measurement, and
wherein an incident angle of X-rays is determined such that an X-ray in a direction parallel to a test surface has an incident angle of 0° while an X-ray in a direction normal to the test surface has an incident angle of 90°; and
wherein the ratio
$$( {I}_{292.5 eV}^{90 °} / {I}_{292.5 eV}^{15 °} )$$
of the peak intensity
$$( {I}_{292.5 eV}^{90 °} )$$
at 292.5 eV when the incident angle is 90° to the peak intensity
$$( {I}_{292.5 eV}^{15 °} )$$
at 292.5 eV when the incident angle is 15° is 0.90 or less.

2. The surface layer according to claim 1, wherein the alkyl group-containing compound comprises two alkyl groups.

3. The surface layer according to claim 1, wherein the at least one alkyl group comprises in total 19 or more carbon atoms.

4. The surface layer according to claim 1, wherein the base material adhesive group in the alkyl group-containing compound is a silanol group, a hydrolysable silyl group, a silazane group, a thiol group, or a phosphonic acid group.

5. The surface layer according to claim 1, wherein the alkyl group-containing compound is represented by any one of formulae (11), (12), and (13) defined as: 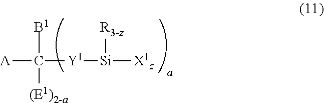
wherein A is an alkyl group having 10 to 50 carbon atoms, B¹ is a hydrogen atom or a hydroxyl group, each E¹ is a hydrogen atom or an alkyl group having 9 to 50 carbon atoms, the total number of carbon atoms contained in A and E¹ is 19 or more, each Y′ is a single bond, an alkylene group, or a divalent hydrocarbon group containing at least one selected from the group consisting of a silicon atom and a siloxane bond, each R is an alkyl group having 1 to 4 carbon atoms or a phenyl group, each X¹ is independently a hydrolyzable group, z is 2 or 3, and a is 1 or 2; 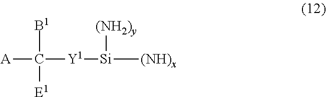
wherein A, B¹, E¹, and Y¹ are as defined above, y is a number of 0 to 3, x is defined as x=(3−y)/2, where the formula (12) denotes a molecular formula of monomer when y=3, while the formula (12) denotes a composition formula of polymer when y<3; and 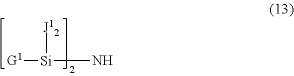
wherein each G¹ independently represents a monovalent hydrocarbon group having 10 to 30 carbon atoms and each J¹ independently represents a hydrogen atom, a hydroxyl group, or a methyl group.

6. The surface layer according to claim 1, wherein the surface layer has a film thickness of 2 to 5 nm.

7. The surface layer according to claim 1, wherein the surface layer endures 1000 abrasion cycles that maintain resistance to abrasion using a reciprocating abrasion tester performed on the surface layer formed on glass,
wherein the number of abrasion cycles that maintain resistance to abrasion is defined as the number of reciprocations that maintain a water contact angle of 90° or greater with respect to the surface in an abrasion resistance test performed under the conditions of:
Abrasion material: Steel wool of #0000 (Bonstar);
Load: 1 kgf;
Reciprocation distance: 40 mm; and
Reciprocation rate: 60 reciprocation cycles per minute.
